(19) United States
(12) Patent Application Publication
(10) Pub. No.: US 2021/0365790 A1
(43) Pub. Date: Nov. 25, 2021

(54) METHOD AND APPARATUS WITH NEURAL NETWORK DATA PROCESSING

(71) Applicants: SAMSUNG ELECTRONICS CO., LTD., Suwon-si (KR); SNU R&DB FOUNDATION, Seoul (KR)

(72) Inventors: Changyong SON, Anyang-si (KR); Minsoo KANG, Seoul (KR); Bohyung HAN, Seoul (KR)

(73) Assignees: SAMSUNG ELECTRONICS CO., LTD., Suwon-si (KR); SNU R&DB FOUNDATION, Seoul (KR)

(21) Appl. No.: 17/148,619

(22) Filed: Jan. 14, 2021

Related U.S. Application Data
(63) Continuation of application No. 63/028,680, filed on May 22, 2020.

(30) Foreign Application Priority Data
Jun. 30, 2020 (KR) 10-2020-0080379

(51) Int. Cl. G06N 3/08; G06N 3/04

(52) U.S. Cl. CPC G06N 3/084; G06N 3/04

(57) ABSTRACT

A processor-implemented neural network data processing method includes: receiving input data; determining a portion of channels to be used for calculation among channels of a neural network based on importance values respectively corresponding to the channels of the neural network; and performing a calculation based on the input data using the determined portion of channels of the neural network.

### CROSS-REFERENCE TO RELATED APPLICATIONS

This application claims the benefit under 35 USC 119(e) of U.S. Provisional Application No. 63/028,680 filed on May 22, 2020, and the benefit under 35 USC 119(a) of Korean Patent Application No. 10-2020-0080379 filed on Jun. 30, 2020, in the Korean Intellectual Property Office, the entire disclosures of which are incorporated herein by reference for all purposes.

### BACKGROUND

### 1. Field

The following description relates to a method and apparatus with neural network data processing.

### 2. Description of Related Art

Technology may perform user authentication using a face or a fingerprint of a user through a recognition model such as a classifier. The recognition model may be based on a neural network that models characteristics by mathematical expressions. The neural network may be used to output a recognition result corresponding to an input pattern of input information. The neural network may have a capability to generate mapping between an input pattern and an output pattern through learning and generate a relatively correct output value for an input pattern yet to be used for learning based on learning results.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented neural network data processing method includes: receiving input data; determining a portion of channels to be used for calculation among channels of a neural network based on importance values respectively corresponding to the channels of the neural network; and performing a calculation based on the input data using the determined portion of channels of the neural network.

The number of channels in the determined portion may vary based on a lightweight degree of the neural network.

The lightweight degree may be a proportion of the channels of the neural network to be used for calculation, and the lightweight degree is determined based on any one or any combination of a memory usage, a processing speed, and a processing time of an apparatus.

The determining may include determining a portion of channels satisfying the lightweight degree based on an order of the importance values of the channels of the neural network.

The order of the importance values may be an order from greatest to least among the importance values.

The determining may include determining a current channel included in the neural network to be a channel to be used for the calculation, in response to an importance value of the current channel being greater than a threshold.

The determining may include determining to deactivate the current channel such that the channel is not used for the calculation, in response to the importance value of the current channel being less than or equal to the threshold.

The threshold may be determined based on a lightweight degree of the neural network.

The importance value of the current channel may be a probability value corresponding to a degree of influence on the calculation for the input data in response to the current channel being deactivated.

The importance values respectively corresponding to the channels may be determined based on cumulative distribution functions (CDFs) of the channels determined by a process of training the neural network.

The determining of the portion of channels may include: determining a binary mask based on the CDFs and a threshold; and determining the portion of channels to be used for the calculation based on the determined binary mask.

Parameters of the CDFs may be learned using a mask having continuous values in the form of a logistic function, in a process of training the neural network.

In the process of training, a differentiable soft mask may be determined using a Gumbel-softmax function, and backward propagation training may be performed based on the soft mask.

The neural network may be a convolutional neural network, and hidden layers of the convolutional neural network may include a convolutional layer, a batch normalization layer, and a rectified linear unit (ReLU) layer.

The determining may include determining channels to be used for calculation for each of hidden layers of the neural network.

The method may include performing object recognition of the input data based on a result of the performing of the calculation, wherein the input data corresponds to image data.

A non-transitory computer-readable storage medium may store instructions that, when executed by a processor, configure the processor to perform the method.

In another general aspect, a neural network data processing apparatus includes: a processor configured to: receive input data, determine a portion of channels to be used for calculation among channels of a neural network based on importance values respectively corresponding to the channels of the neural network, and perform a calculation based on the input data using the determined portion of channels of the neural network.

For the determining, the processor may be configured to determine the portion of channels to be used for the calculation based on a lightweight degree of the neural network.

For the determining, the processor may be configured to determine a current channel included in the neural network to be a channel to be used for the calculation, in response to an importance value of the current channel being greater than a threshold, and the threshold may be determined based on a lightweight degree required for the neural network.

The importance values respectively corresponding to the channels may be determined based on cumulative distribution functions (CDF) of the channels determined by a process of training the neural network.

The apparatus may include a memory storing instructions that, when executed by the processor, configure the processor to perform the receiving, the determining, and the performing.

In another general aspect, a neural network data processing electronic device includes: a processor configured to: receive input data, determine a portion of channels to be used for calculation among channels of a neural network based on importance values respectively corresponding to the channels of the neural network, and perform a calculation based on the input data using the determined portion of channels of the neural network.

For the determining, the processor may be configured to determine a current channel included in the neural network to be a channel to be used for the calculation, in response to an importance value of the current channel being greater than a threshold, and the threshold may be determined based on a lightweight degree required for the neural network.

In another general aspect, a processor-implemented neural network data processing method includes: receiving input data; determining a channel included in a neural network to be a channel to be used for performing recognition based on a cumulative distribution function (CDF) of the channel learned using a mask having continuous values in the form of a logistic function; and performing the recognition based on the input data using the determined channel.

Other features and aspects will be apparent from the following detailed description, the drawings, and the claims.

### BRIEF DESCRIPTION OF THE DRAWINGS

FIG. 1 illustrates an example of a system for processing data using a neural network.

FIG. 2 illustrates an example of a method of processing data using a neural network.

FIG. 3 illustrates an example of channel pruning of a neural network.

FIG. 4 illustrates examples of batch normalization distributions.

FIG. 5 illustrates an example of a training process.

FIG. 6 illustrates examples of applying a mask to a feature map in a training process.

FIG. 7 illustrates an example of a configuration of a data processing apparatus for processing data using a neural network.

FIG. 8 illustrates an example of a configuration of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

As used herein, the singular forms are intended to include the plural forms as well, unless the context clearly indicates otherwise. The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The use of the term “may” herein with respect to an example or embodiment (e.g., as to what an example or embodiment may include or implement) means that at least one example or embodiment exists where such a feature is included or implemented, while all examples are not limited thereto.

Unless otherwise defined herein, all terms used herein including technical or scientific terms have the same meanings as those generally understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

Hereinafter, examples will be described in detail with reference to the accompanying drawings. When describing the examples with reference to the accompanying drawings, like reference numerals refer to like constituent elements and a repeated description related thereto will be omitted.

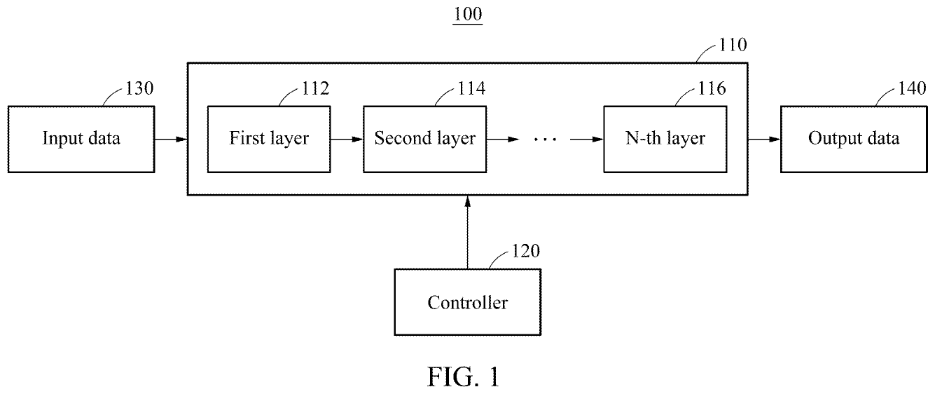

FIG. 1 illustrates an example of a system for processing data using a neural network.

Referring to FIG. 1, a system 100 for processing data, hereinafter, the data processing system 100, may be a system that processes input data 130 using a neural network 110 and outputs output data 140 as a result of processing the input data 130. The data processing system 100 may extract, as the output data 140, feature values for object recognition from the input data 130 using the neural network 110 and determine a result of the object recognition based on the extracted feature values. At least a portion of processing operations related to the neural network 110 may be implemented by hardware including a neural processor, or implemented by hardware implementing instructions. The data processing system 100 may be mounted in or may include, for example, a mobile phone, a desk top, a laptop, a tablet PC, a wearable device, a smart TV, an intelligent vehicle, a security system, a smart home system, and a smart home appliance.

The neural network 110 may provide an optimal output corresponding to an input by mapping an input and an output that are in a non-linear relationship, based on deep learning. Deep learning is a machine learning technique for solving given problems from a large data set, and is a process of optimizing the neural network 110 by finding parameters (for example, weights) or a model that represents a structure of the neural network 110.

The neural network 110 is a deep neural network (DNN), and may be, for example, a convolutional neural network (CNN). However, the neural network 110 used by the data processing system 100 is not limited thereto. The CNN may be used for processing two-dimensional (2D) data such as images. The CNN may perform a convolution operation between an input map and a weight kernel to process 2D or 3D data, and a typical data processing system may use a large amount of resources and a long processing time to perform the convolution operation in an environment where resources are limited, such as a mobile terminal. In contrast, the data processing system 100 of one or more embodiments may perform object recognition (e.g., face recognition) when implemented on or as a mobile terminal even when the mobile terminal is an environment having limited resources and when the mobile terminal requires providing a recognition performance that is robust under various conditions. To this end, the data processing system 100 of one or more embodiments may process data fast without a significant decrease in the recognition performance, in contrast to the typical data processing system.

When processing the input data 130 using the neural network 110, the data processing system 100 of one or more embodiments may effectively solve the issues of the typical data processing system mentioned above by lightening the neural network 110 under the control of a controller 120. Such lightening may include pruning one or more channels from among channels of layers 112, 114, and 116 in the neural network 110. Pruning a portion of channels of the neural network 110 may refer to, for example, deactivating the portion of the channels or removing an input and an output of the portion of the channels. Pruning may reduce the number of channels to be used during the operation of the neural network 110.

When pruning a channel of the neural network 110, the controller 120 may dynamically prune the channel based on an importance value of the channel. The controller 120 may prune the channel according to the system requirements. For example, the requirements may include a determined allowable memory usage or a determined required processing speed/processing time. A lightweight degree (or lightening degree) required for the neural network 110 may be determined according to the system requirements, and channels to be pruned or the number of channels to be pruned may be determined based on the determined lightweight degree. For example, when a limitation to the resources such as a memory usage increases according to the system requirements, the lightweight degree determined for the neural network 110 may increase. When the determined lightweight degree increases, the number of channels to be deactivated during a calculation process of the neural network 110 may increase, and a probability that a channel having a relatively low importance value is deactivated may increase.

An importance value of a channel may indicate, when the channel is pruned and deactivated, a degree of influence of the deactivated channel on the neural network 110 calculating the input data 130, and may be defined or modeled as a probability value. When a predetermined channel plays an important role in the calculation process within the neural network 110, an importance value of the channel may be set high. Conversely, when the channel plays a relatively less important role in the calculation process, the importance value of the channel may be set low. An importance value of each channel of the neural network 110 may be determined during a process of training the neural network 110, and may be optimized through, for example, a backward propagation training process. In the training process, the importance value of each channel may be determined by determining a cumulative distribution function (CDF) of each channel based on batch normalization parameter values and by modeling a probability relating to a degree of influence of each channel on calculation when each channel is deactivated through applying a logistic function to the CDF. Herein, the term “importance value” may also be referred to as “channel sensitivity”.

The examples set forth herein may dynamically perform pruning of the neural network 110 using the importance values of the channels, thereby increasing the processing speed without greatly decreasing the performance of the neural network 110 by increasing the resource utilization or the processing speed in an environment with limited resources such as a mobile device, a portable device, or a smart sensor, without using an accelerator and additionally changing the hardware structure. The performance of the neural network 110 may be degraded when all the channels are unavailable by channel pruning. However, according to the examples, the data processing system 100 of one or more embodiments may process data at a high speed while maintaining high accuracy in an environment with limited resources.

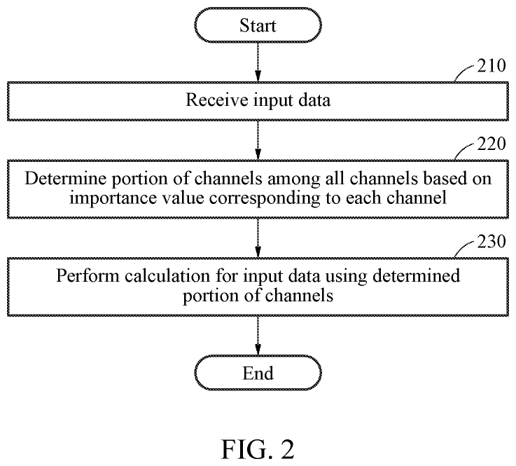

FIG. 2 illustrates an example of a method of processing data using a neural network.

In operation 210, a data processing apparatus of one or more embodiments may receive input data. For example, the data processing apparatus may receive image data or audio data as the input data. However, the types of the input data to be processed by the data processing apparatus are not limited thereto.

In operation 220, the data processing apparatus may determine a portion of channels to be used for calculation among channels of a neural network, by performing channel pruning based on an importance value corresponding to each channel included in the neural network. For example, in the determined portion of channels, a convolution operation or a batch normalization operation may be performed. The importance value of each channel of the neural network may be a probability value relating to a degree of influence on the calculation of the input data when each channel is deactivated. The importance value corresponding to each channel of the neural network may be based on a CDF of each channel determined in a process of training the neural network.

The data processing apparatus may determine whether to prune and deactivate, or maintain a channel in the neural network according to a lightweight degree required or determined for the neural network. Depending on the lightweight degree required or determined for the neural network, the number of channels in the portion to be used for calculation in the neural network may vary. For example, if the required or determined lightweight degree is high, the number of channels to be used for calculation may decrease. Conversely, if the required or determined lightweight degree is low, the number of channels to be used for calculation may relatively increase. The data processing apparatus may determine a portion of channels satisfying the lightweight degree based on an order of importance values of channels of the neural network. The data processing apparatus may arrange the channels based on the importance values, select a predetermined number of channels in order of greater importance values, and deactivate unselected channels. For example, when the required lightweight degree is 30%, the data processing apparatus may select, as the portion of channels to be used for calculation, only channels that have greater importance values and correspond to 70% of all the channels of the neural network (e.g., data processing apparatus may select, from among all the channels, the 70% with the greatest importance value).

The data processing apparatus may perform channel pruning by comparing the importance values of the channels to a threshold. For example, when an importance value of a current channel included in the neural network is greater than the threshold, the data processing apparatus may determine and select the current channel to be a channel to be used for calculation. Conversely, when the importance value of the current channel is less than or equal to the threshold, the data processing apparatus may determine to deactivate the current channel. Here, the threshold may be determined based on the lightweight degree required for the neural network. For example, when the required lightweight degree is high, the threshold may be set to a great value. Conversely, when the required lightweight degree is low, the threshold may be set to a relatively small value.

The data processing apparatus may determine a binary mask based on a CDF of each channel of the neural network and the threshold, and determine the portion of channels to be used for calculation based on the determined binary mask. The CDF of each channel may be determined during the process of training the neural network, and an area value of the CDF may correspond to an importance value. In the process of training the neural network, parameters of the CDF corresponding to each channel may be learned using a mask (for example, a probability mask or a continuous mask) having continuous values in the form of a logistic function. In the mask, a channel having a small probability value may indicate that the channel is relatively important, and thus, the channel may have a great importance value. In addition, in the process of training the neural network, a differentiable soft mask may be defined using a Gumbel-softmax function, and backward propagation training may be performed based on the soft mask.

The channel pruning process described above may be performed for each hidden layer of the neural network, such that a channel to be deactivated may be determined among output channels of each hidden layer based on importance values. As a result of channel pruning, input channels to be deactivated may be removed from an (n+1)-th layer following an n-th layer of the neural network, based on the number of channels to be pruned (or deactivated) from the n-th layer. This removal process may be sequentially processed between successive layers.

In operation 230, the data processing apparatus may perform a calculation for the input data using the determined portion of channels of the neural network. As a result of the calculation, predetermined result values may be output from the neural network. Since the data processing apparatus of one or more embodiments may not perform a calculation on a channel pruned and deactivated in the process of processing the input data using the neural network, the processing time may be reduced, and fast processing may be enabled. In addition, through the pruning process based on the importance values of the channels as described above, the data processing apparatus of one or more embodiments may reduce the size of the neural network and the required amount of resources such as memory storage while minimizing deterioration in the performance of the neural network.

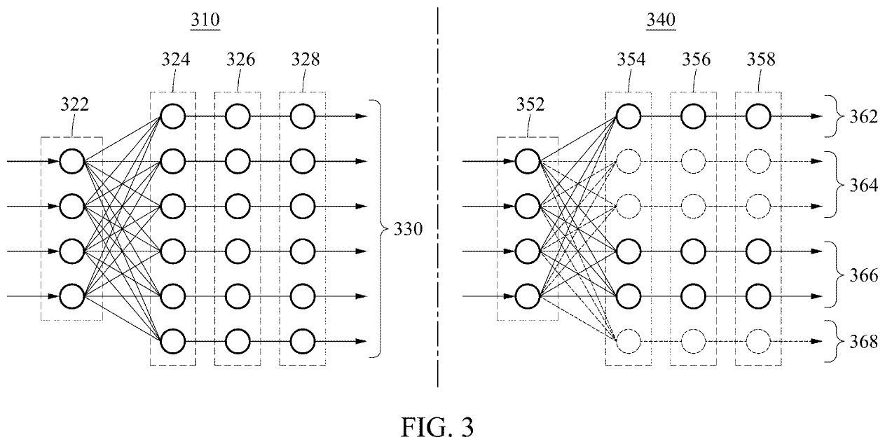

FIG. 3 illustrates an example of channel pruning of a neural network.

In the example of FIG. 3, a neural network may be a CNN. In a first case 310, an input layer 322 and a hidden layer connected to the input layer 322 are illustrated as part of the CNN. The hidden layer may have a configuration in which a convolutional layer 324, a batch normalization layer 326, and a ReLU layer 328 are sequentially connected. Other hidden layers of the CNN (e.g., hidden layers subsequent to the hidden layer) may also have the same or similar configuration. The CNN of a second case 340 also includes an input layer 352 and a hidden layer connected to the input layer 352, and that the hidden layer has a configuration in which a convolutional layer 354, a batch normalization layer 356, and a ReLU layer 358 are sequentially connected. The convolutional layers 324 and 354 may determine feature values by performing a convolution operation on the input data, and the batch normalization layers 326 and 356 may perform batch normalization processing including normalization and affine transformation on the determined feature values, for example. The batch normalization processing includes, for example, performing affine transformation using batch normalization parameters after normalizing input values (e.g., the determined feature values) by a mean and variance. The ReLU layers 328 and 358 perform the function of a ReLU function, which is an activation function, on results of the batch normalization processing of the normalization layers 326 and 356, respectively, for example.

The first case 310 shows an example of using all channels 330 of the hidden layer for calculation without channel pruning. The first case 310 requires a large amount of resources and a long time for calculation. As a solution to this issue, the data processing apparatus of one or more embodiments may perform channel pruning as in the second case 340. As a result of channel pruning, only a portion of channels 362 and 366 among all the channels 362, 364, 366, and 368 of the hidden layer may be used for calculation, and the remaining channels 364 and 368 may be deactivated. The channel pruning process of determining a portion of channels to be used for calculation may be performed for each hidden layer of the neural network.

The data processing apparatus may dynamically determine the portion of channels to be used for calculation according to a lightweight degree required for the neural network during the channel pruning process. The data processing apparatus may set a predetermined threshold according to the required lightweight degree, and determine a channel to be deactivated by comparing an importance value of each channel to the threshold. The importance value of each channel may be based on a value of a CDF of each channel determined during a process of training the neural network. The importance value of the channel and the value of the CDF may be inversely related to each other. In another example, the data processing apparatus may select a predetermined number of top channels in an order of greater importance values according to the required lightweight degree, and perform a calculation using the selected channels. Unselected channels may be deactivated. As such, by using only relatively important channels for calculation in view of lightweight degrees, the data processing apparatus of one or more embodiments may enable fast processing that satisfies the system requirements without greatly decreasing the performance of the neural network.

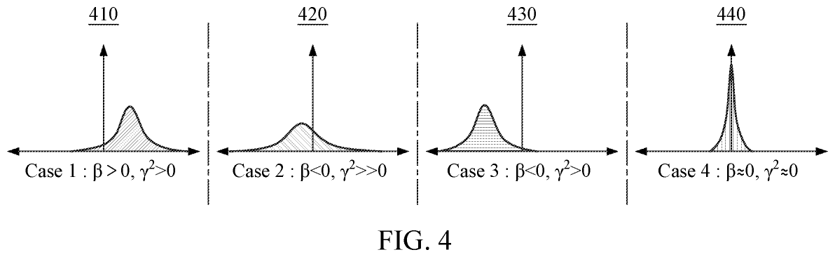

FIG. 4 illustrates examples of batch normalization distributions.

When a batch normalization layer and a ReLU layer of a neural network are applied together, the convergence speed of the neural network may be accelerated through the batch normalization layer, and the neural network may be trained more stable. The batch normalization layer may normalize values of each channel by calculating a mean and a standard deviation of the channel, and perform an affine transformation on the normalized values using a shift parameter β and a scale parameter γ. In FIG. 4, Case 1 410, Case 2 420, Case 3 430, and Case 4 440 show batch normalization distributions under various conditions. In Cases 410, 420, 430, and 440, the normalized values may follow a standard normal distribution, and the results of performing the affine transformation follow a normal distribution having a mean β and a variance γ².

Based on the above distributions, the probability that channels are deactivated by a ReLU function when values output from the channels of the batch normalization layer are inputted into the ReLU layer may be relatively high in Case 3 430 and Case 4 440 of FIG. 4. This is because regardless of the input values, channels corresponding to Case 3 430 or Case 4 440 have values close to “0” (e.g., Case 4 440), or are deactivated with high probability by the ReLU function that deactivates even negative-valued parts (e.g., Case 3 430). For example, in Case 4 most of the activations are close to zero, and in Case 3 430 most of the activations are negative and may be zero after applying the ReLU function. Accordingly, even when the channels corresponding to Case 3 430 or Case 4 440 are pruned and deactivated, the subsequent calculation will not be greatly affected. When an importance value of each channel is modeled, the importance value may be modeled to increase the possibility that a channel corresponding to Case 3 430 to be deactivated by the ReLU function is pruned, whereby channels with low influence may be deactivated more. In Case 1 410 and Case 2 420, the channels are likely not to be deactivated by the ReLU function (e.g., due to their positive values).

A probability of being less than a hyperparameter δ which is close to “0”, may be calculated using a CDF of a normal distribution N(β, γ²) to model the probability that the channel is deactivated, and a binary mask indicating whether to prune and deactivate or maintain the channel may be determined. The value of the binary mask may be set to “1” when the value of the CDF is greater than or equal to a predetermined value c, and may be set to “0” when the value of the CDF is less than the predetermined valued c. For example, the CDF Φ(β,γ;δ) of a Gaussian distribution and based on the hyperparameter δ, which is a predetermined threshold, and the binary mask m(β,γ;δ) based on the CDF Φ(β,γ;δ) may be determined as expressed by Equation 1 below, for example.

$$m ( β , γ ; δ ) = \{ \begin{matrix}1 & if Φ ( β , γ ; δ ) \geq c \\ 0 & otherwise\end{matrix} , \\ where Φ ( β , γ ; δ ) = {\int }_{- ∞}^{δ} f ( t , β , γ ) dt \qquad Equation 1$$

When the mask is defined in the form of an indicator function as shown in Equation 1 above, differentiation (e.g., with respect to β and γ) and general backward propagation learning may not be performed. In order to enable backward propagation learning, a logistic function may be used in the process of training the neural network so that the binary mask m(β,γ;δ) may be expressed as continuous values. Through the logistic function, an approximation process may be performed to have a value greater than or equal to 0.5 when the value of the CDF is greater than or equal to the predetermined value c and to have a value less than 0.5 when the value of the CDF is less than the predetermined value c.

In the actual data processing process other than the training process, the value of the mask should be set to “0” or “1” like the binary mask, and thus a large discrepancy may occur between the training process and the actual data processing process. To solve the performance degradation due to this discrepancy, a Gumbel-softmax function may be used in the training process. A differentiable soft mask may be defined using a Gumbel-softmax function, and backward propagation training may be performed based on the soft mask. By using the Gumbel-softmax function, the value of the soft mask may be maintained as close to the binary value as possible, and backward propagation integrated learning may be enabled. In addition, since the mask and the parameters of the neural network are learned interactively during the process of training the neural network, a high-performance trained neural network may be obtained without a separate fine-tuning process.

In another example, as shown in Case 4 440, channel pruning may be performed in view of only a case in which the range of the batch normalization distribution is narrow and an absolute value of a CDF is small. To this end, instead of modeling the probability regarding whether to prune a channel through the CDF, the probability that the value of the CDF of the channel is greater than a and less than b may be calculated using hyperparameters a (negative number) and b (positive number) of which the absolute values are small, and an importance value of the channel (or the probability that the channel is pruned) may be modeled based on the calculated probability.

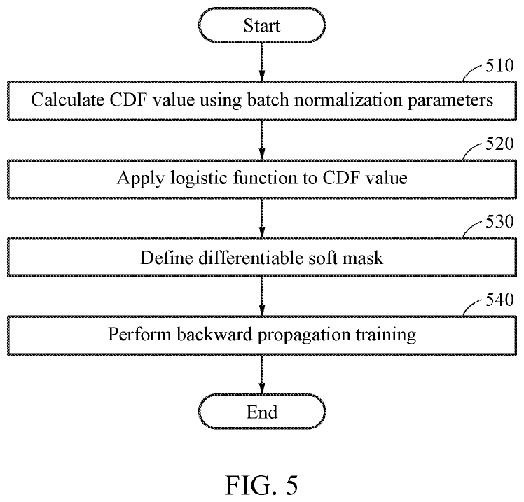

FIG. 5 illustrates an example of a training process. A training process may be performed by a training apparatus including a processor.

Referring to FIG. 5, in operation 510, the training apparatus may calculate a value of a CDF using batch normalization parameters. The batch normalization parameters may include a shift parameter β and a scale parameter γ, and the value of the CDF may be defined based on the CDF Φ(β,γ;δ) in Equation 1 above, for example.

In operation 520, the training apparatus may define a differentiable probability mask (or continuous mask) by applying a logistic function to the value of the CDF. Unlike the data processing process, a differentiable probability mask may be used instead of a binary mask in the training process. The corresponding probability mask may be defined by a CDF based on batch normalization parameters of each channel.

Since the binary mask is a non-differentiable form, a process of applying the logistic function to the CDF Φ(β,γ;δ) may be performed for a differentiable form, and the probability mask q(β,γ;δ) defined as a result of the applying may be defined in the form of a differentiable function, as expressed by Equation 2 below, for example. Through Equation 2, an indicator function of the binary mask may be approximated to the logistic function.

$$q ( β , γ ; δ ) = \frac{1}{1 + exp ( - k ( Φ ( β , γ ; δ ) - c ) )} \qquad Equation 2$$

Here, k is a constant, and c corresponds to the predetermined value c defined in Equation 1. The value of the probability mask q(β,γ;δ) may indicate a probability that a corresponding feature map is deactivated by a ReLU layer.

In operation 530, the training apparatus may define a differentiable soft mask n(β,γ;δ) using a Gumbel-softmax function. The Gumbel-softmax function is a softmax function that performs sampling to approximate a discrete random variable. The soft mask n(β,γ;δ) may be defined or sampled, as expressed by Equation 3 below, for example, based on the probability mask q(β,γ;δ).

$$n ( β , γ ; δ ) = \frac{exp ( ( log ( 1 - q ( β , γ ; δ ) ) + {g}_{1} ) / τ )}{exp ( ( log ( 1 - q ( β , γ ; δ ) ) + {g}_{1} ) / τ ) + exp ( ( log q ( β , γ ; δ ) + {g}_{0} ) / τ )} \qquad Equation 3$$

Here, g₀ and g₁ denote samples sampled from the Gumbel (0, 1) distribution. g₀ and g₁ may be given by a relation of g(u)=−log(−log(u)), where u˜Uniform(0, 1). τ may be a set small value.

In operation 540, the training apparatus may perform backward propagation training based on the soft mask n(β,γ;δ). Training may include a process of optimizing the parameters of the neural network and the mask for channel pruning together, wherein the parameters of the neural network may be updated by a gradient-based method, for example.

The training process of the soft mask n(β,γ;δ) may be as follows.

First, a result z of normalization performed at a batch normalization layer of the neural network may be defined as expressed by Equation 4 below, for example, and a result x″^{t} of applying the soft mask n(β,γ;δ) to an output of the batch normalization layer may be expressed by Equation 5 below, for example.

$$\begin{matrix}z = \frac{{x}^{in} - \hat{μ}}{\sqrt{{\hat{σ}}^{2} + ϵ}} & Equation 4 \\ {x}^{out} = ( γ \cdot z + β ) \cdot n ( β , γ ; δ ) & Equation 5\end{matrix}$$

Here, xⁱⁿ is an input value that is inputted into the batch normalization layer, and û and \hat{σ}² denote a mean and a variance of input values, respectively. ∈ is a small value to prevent the denominator of Equation 4 from becoming “0”. β and γ are parameters that may be learned, and denote the shift parameter and the scale parameter of the batch normalization layer, respectively.

Results of partial derivatives of x^{out} for β and γ may be respectively expressed by Equation 6 and Equation 7 below, for example.

$$\begin{matrix}\frac{\partial {x}^{out}}{\partial γ} = z \cdot n ( β , γ ; δ ) + ( γ \cdot z + β ) \cdot \frac{\partial n ( β , γ ; δ )}{\partial γ} & Equation 6 \\ \frac{\partial {x}^{out}}{\partial β} = z \cdot n ( β , γ ; δ ) + ( γ \cdot z + β ) \cdot \frac{\partial n ( β , γ ; δ )}{\partial β} & Equation 7\end{matrix}$$

Here,

$$\frac{\partial n ( β , γ ; δ )}{\partial γ}$$

may be expressed by Equation 8 below, and

$$\frac{\partial n ( β , γ ; δ )}{\partial β}$$

may be expressed by Equation 9 below, for example.

$$\begin{matrix}\frac{\partial n ( β , γ ; δ )}{\partial γ} = \frac{\partial n ( β , γ ; δ )}{\partial q ( β , γ ; δ )} \cdot \frac{\partial n ( β , γ ; δ )}{\partial Φ ( β , γ ; δ )} \cdot \frac{\partial Φ ( β , γ ; δ )}{\partial γ} & Equation 8 \\ \frac{\partial n ( β , γ ; δ )}{\partial β} = \frac{\partial n ( β , γ ; δ )}{\partial q ( β , γ ; δ )} \cdot \frac{\partial n ( β , γ ; δ )}{\partial Φ ( β , γ ; δ )} \cdot \frac{\partial Φ ( β , γ ; δ )}{\partial β} & Equation 9\end{matrix}$$

The partial derivatives of Equations 8 and 9 may be summarized as in Equations 10 to 12 below, for example.

$$\begin{matrix}\frac{\partial n ( β , γ ; δ )}{\partial q ( β , γ ; δ )} = - \frac{n ( β , γ ; δ ) ( 1 - n ( β , γ ; δ ) )}{τ q ( β , γ ; δ ) ( 1 - q ( β , γ ; δ ) )} & Equation 10 \\ \frac{\partial Φ ( β , γ ; δ )}{\partial β} = - f ( δ , β , γ ) \cdot \frac{δ - B}{\vert γ \vert} \cdot \frac{\partial \vert γ \vert}{\partial γ} & Equation 11 \\ \frac{\partial Φ ( β , γ ; δ )}{\partial β} = - f ( δ , β , γ ) & Equation 12\end{matrix}$$

Here,

$$\frac{\partial q ( β , γ ; δ )}{\partial Φ ( β , γ ; δ )}$$

is given by Equation 13 below, for example, and

$$\frac{\partial Φ ( β , γ ; δ )}{\partial γ}$$

in Equation 11 may be differentiated in other intervals except for “0”. Equations 10 to 12 indicate that the parameters β and γ may be learned through a general backward propagation training technique.

$$\frac{\partial q ( β , γ ; δ )}{\partial Φ ( β , γ ; δ )} = k \cdot q ( β , γ ; δ ) \cdot ( 1 - q ( β , γ ; δ ) ) \qquad Equation 13$$

Equation 13 represents a partial derivative of the logistic function with respect to the CDF Φ(β,γ;δ), wherein k corresponds to k in Equation 2.

In the above training process, an importance value of each channel of the neural network model may be determined by determining a CDF of each channel based on batch normalization parameter values and by modeling the probability regarding a degree of influence of each channel on calculation when each channel is deactivated, by applying the logistic function to the CDF. When the importance value determined in the training process of one or more embodiments is used for pruning, there is no need to perform a fine-tuning process to minimize the decrease in accuracy of the neural network due to typical channel pruning. A great importance value of a channel may indicate that a result obtained while the channel is deactivated may cause a great error, and a small importance value of a channel may indicate that a result obtained while the channel is deactivated may cause a relatively small error.

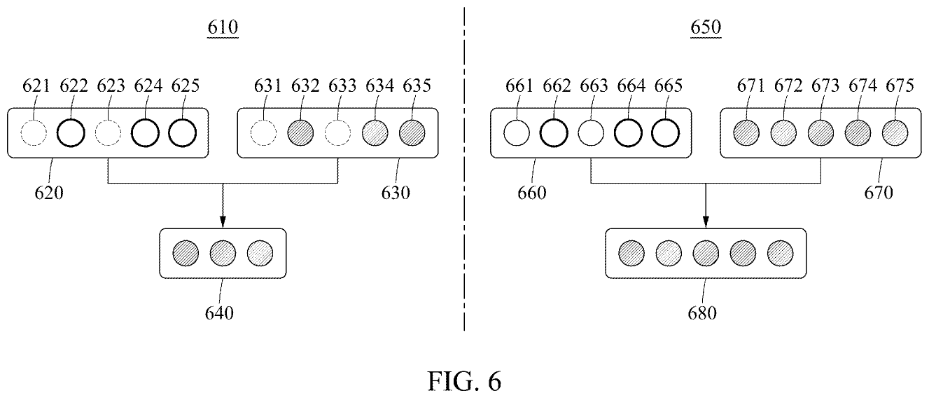

FIG. 6 illustrates examples of applying a mask to a feature map in a training process.

Referring to FIG. 6, an applying of a mask 610 shows a feature map 640 to which a binary mask 620 is applied. In detail, the feature map 640 may be obtained by applying, to a feature map 630, the binary mask 620 representing mask values 621 and 623 of “0” and mask values 622, 624, and 625 of “1” in relation to an existing training process. Through applying the binary mask 620, the mask values 621 and 623 of “0” are applied to feature values 631 and 633 in the feature map 630, such that the feature values 631 and 633 may not be reflected in the feature map 640, and only feature values 632, 634, and 635 to which the mask values 622, 624, and 625 of “1” are applied may be reflected in the feature map 640. In a typical training process, the capacity of the neural network may decrease according to the application of the binary mask 620, and updating the parameters of the neural network based on the feature values 631 and 633 may not be performed. This may lead to deterioration of the performance of the neural network generated by the typical training process, and a fine-tuning process for the parameters of the neural network is required to overcome this issue, and thus the complexity of the training process and the training time may increase.

In contrast, in a training process of one or more embodiments, an applying of a mask 650 shows a feature map 680 to which a soft mask 660 is applied. In detail, the feature map 680 may be obtained by applying a differentiable soft mask 660 to a feature map 670 in a training process. The differentiable soft mask 660 may be defined as a probability value based on a CDF, rather than having a binary value. For example, mask values 661 and 663 may have low probability values (e.g., yet greater than zero), and mask values 662, 664, and 665 may have relatively high probability values. The mask values 661, 662, 663, 664, and 665 are applied to feature values 671, 672, 673, 674, and 675, respectively, such that feature values of the feature map 680 are determined. In the training process, by using the differentiable soft mask 660, the parameters of the neural network and all the mask values 661, 662, 663, 664, and 665 may be updated together based on all the feature values 671, 672, 673, 674, and 675 of the feature map 670, without reducing the size of the feature map 680. In addition, since training is performed while maintaining the capacity of the neural network, a high-performance neural network may be obtained without a separate fine-tuning process, and the training process may be performed faster.

The feature maps 630 and 670 may also be referred to as “activations”, “activation data”, or “activation maps”, and may correspond to the outputs of a convolutional layer.

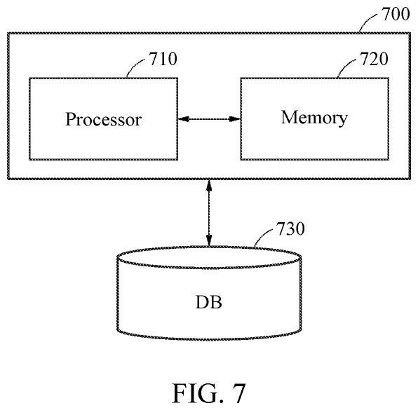

FIG. 7 illustrates an example of a configuration of a data processing apparatus for processing data using a neural network.

A data processing apparatus 700 may perform one or more operations described or illustrated herein in relation to a data processing method. Referring to FIG. 7, the data processing apparatus 700 may include at least one processor 710 and a memory 720. The memory 720 may be connected to the processor 710, and store instructions executable by the processor 710, data to be computed by the processor 710, or data processed by the processor 710. The memory 720 may include non-transitory computer-readable media, for example, a high-speed random-access memory and/or a non-volatile computer-readable storage medium.

The processor 710 may process data using a neural network and perform the function of the controller 120 of FIG. 1. Parameters for implementing the neural network may be stored in a database 730.

When processing input data using the neural network, the processor 710 may perform channel pruning according to the system requirements. The processor 710 may receive the input data and determine a portion of channels to be used for calculation among all channels of the neural network based on an importance value corresponding to each channel included in the neural network. The importance value corresponding to each channel may be based on a CDF of each channel determined in a process of training the neural network, and may be already stored in the database 730.

The processor 710 may determine the portion of channels to be used for calculation, based on a lightweight degree required for the neural network according to the system requirements. For example, the processor 710 may determine a threshold based on the lightweight degree required for the neural network according to the system requirements, and compare the importance value of each channel of the neural network to the threshold. If an importance value of a channel included in the neural network is greater than the threshold, the channel may be determined to be used for calculation. If the importance value is less than or equal to the threshold, the channel may be pruned and deactivated. Calculation may not be performed on the deactivated channel. In another example, the processor 710 may select a predetermined number of channels in order of greater importance values based on the lightweight degree required for the neural network, and perform a calculation based on the selected channels. Unselected channels may be deactivated. The processor 710 may perform a calculation for the input data using the determined portion of channels and determine output data.

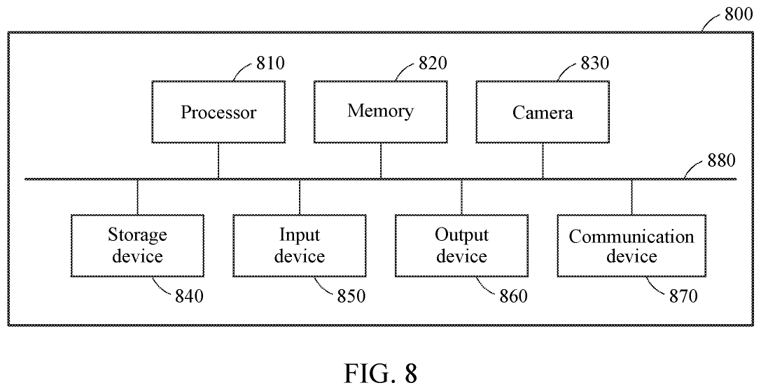

FIG. 8 illustrates an example of a configuration of an electronic device.

The data processing system/apparatus described herein may be included and operate in an electronic device 800, and the electronic device 800 may perform one or more operations that may be performed by the data processing system/apparatus. The electronic device 800 may be, for example, a mobile phone, a wearable device, a tablet computer, a netbook, a laptop, a desktop, a personal digital assistant (PDA), a set-top box, a smart home appliance, a security device, or the like.

Referring to FIG. 8, the electronic device 800 may include a processor 810, a memory 820, a camera 830, a storage device 840, an input device 850, an output device 860, and a communication device 870. The processor 810, the memory 820, the camera 830, the storage device 840, the input device 850, the output device 860, and the communication device 870 may communicate with each other through a communication bus 880.

The camera 830 may acquire a still image, a video image, or both as image data. The acquired image data may be, for example, a color image, a black-and-white image, or an infrared image.

The processor 810 may execute instructions or functions to be executed in the electronic device 800. For example, the processor 810 may process the instructions stored in the memory 820 or the storage device 840, and may perform the one or more operations described above with reference to FIGS. 1 to 7. The processor 810 may process the image data acquired through the camera 830 using the neural network for object recognition or object verification.

When processing the input data using the neural network, the processor 810 may lighten the neural network by performing channel pruning according to the system requirements. The processor 810 may receive the input data and determine a portion of channels to be used for calculation among all channels of the neural network based on an importance value corresponding to each channel included in the neural network. The processor 810 may perform a calculation for the input data using the determined portion of channels and determine output data.

The storage device 840 includes a computer-readable storage medium or computer-readable storage device. The storage device 840 may include a database to store the neural network. The storage device 840 may include a magnetic hard disk, an optical disk, a flash memory, an electrically programmable memory (EPROM), a floppy disk, or other types of non-volatile memories known in the art.

The input device 850 may receive an input from a user through a tactile, video, audio, or touch input. For example, the input device 850 may include a keyboard, a mouse, a touch screen, a microphone, or any other device capable of detecting the input from the user and transmits the detected input to the electronic device 800.

The output device 860 may provide an output of the electronic device 800 to the user through a visual, auditory, or tactile channel. The output device 860 may include, for example, a liquid crystal display, a light-emitting diode (LED) display, a touch screen, a speaker, a vibration generator, or any other device that provides the output to the user.

The communication device 870 may communicate with an external device through a wired or wireless network.

The data processing systems, controllers, data processing apparatuses, processors, memories, databases, electronic devices, cameras, storage devices, input devices, output devices, communication devices, communication buses, data processing system 100, controller 120, data processing apparatus 700, processor 710, memory 720, database 730, electronic device 800, processor 810, memory 820, camera 830, storage device 840, input device 850, output device 860, communication device 870, communication bus 880, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A processor-implemented neural network data processing method, the method comprising:
receiving input data;
determining a portion of channels to be used for calculation among channels of a neural network based on importance values respectively corresponding to the channels of the neural network; and
performing a calculation based on the input data using the determined portion of channels of the neural network.

2. The method of claim 1, wherein the number of channels in the determined portion varies based on a lightweight degree of the neural network.

3. The method of claim 2, wherein the lightweight degree is a proportion of the channels of the neural network to be used for calculation, and the lightweight degree is determined based on any one or any combination of a memory usage, a processing speed, and a processing time of an apparatus.

4. The method of claim 2, wherein the determining comprises determining a portion of channels satisfying the lightweight degree based on an order of the importance values of the channels of the neural network.

5. The method of claim 4, wherein the order of the importance values is an order from greatest to least among the importance values.

6. The method of claim 1, wherein the determining comprises determining a current channel included in the neural network to be a channel to be used for the calculation, in response to an importance value of the current channel being greater than a threshold.

7. The method of claim 6, wherein the determining comprises determining to deactivate the current channel such that the channel is not used for the calculation, in response to the importance value of the current channel being less than or equal to the threshold.

8. The method of claim 6, wherein the threshold is determined based on a lightweight degree of the neural network.

9. The method of claim 6, wherein the importance value of the current channel is a probability value corresponding to a degree of influence on the calculation for the input data in response to the current channel being deactivated.

10. The method of claim 1, wherein the importance values respectively corresponding to the channels are determined based on cumulative distribution functions (CDFs) of the channels determined by a process of training the neural network.

11. The method of claim 10, wherein the determining of the portion of channels comprises:
determining a binary mask based on the CDFs and a threshold; and
determining the portion of channels to be used for the calculation based on the determined binary mask.

12. The method of claim 10, wherein parameters of the CDFs are learned using a mask having continuous values in the form of a logistic function, in a process of training the neural network.

13. The method of claim 12, wherein in the process of training, a differentiable soft mask is determined using a Gumbel-softmax function, and backward propagation training is performed based on the soft mask.

14. The method of claim 1, wherein
the neural network is a convolutional neural network, and
hidden layers of the convolutional neural network include a convolutional layer, a batch normalization layer, and a rectified linear unit (ReLU) layer.

16. The method of claim 1, wherein the determining comprises determining channels to be used for calculation for each of hidden layers of the neural network.

16. A non-transitory computer-readable storage medium storing instructions that, when executed by a processor, configure the processor to perform the method of claim 1.

17. A neural network data processing apparatus, the apparatus comprising:
a processor configured to:
receive input data,
determine a portion of channels to be used for calculation among channels of a neural network based on importance values respectively corresponding to the channels of the neural network, and
perform a calculation based on the input data using the determined portion of channels of the neural network.

18. The apparatus of claim 17, wherein, for the determining, the processor is configured to determine the portion of channels to be used for the calculation based on a lightweight degree of the neural network.

19. The apparatus of claim 17, wherein
for the determining, the processor is configured to determine a current channel included in the neural network to be a channel to be used for the calculation, in response to an importance value of the current channel being greater than a threshold, and
the threshold is determined based on a lightweight degree required for the neural network.

20. The apparatus of claim 17, wherein the importance values respectively corresponding to the channels are determined based on cumulative distribution functions (CDF) of the channels determined by a process of training the neural network.

21. A neural network data processing electronic device, the electronic device comprising:
a processor configured to:
receive input data;
determine a channel included in a neural network to be a channel to be used for performing recognition based on a cumulative distribution function (CDF) of the channel learned using a mask having continuous values in the form of a logistic function; and
perform the recognition based on the input data using the determined channel.
